(19) United States
(12) Patent Application Publication
(10) Pub. No.: US 2025/0344120 A1
(43) Pub. Date: Nov. 6, 2025

(54) MOBILITY MANAGEMENT METHOD AND COMMUNICATION APPARATUS

(71) Applicant: HUAWEI TECHNOLOGIES CO., LTD., Shenzhen (CN)

(72) Inventors: Yu Wang, Hangzhou (CN); Xian Meng, Hangzhou (CN); Yunfei Qiao, Hangzhou (CN); Ying Chen, Hangzhou (CN); Jiayin Zhang, Shanghai (CN)

(73) Assignee: HUAWEI TECHNOLOGIES CO., LTD., Shenzhen (CN)

(21) Appl. No.: 19/265,491

(22) Filed: Jul. 10, 2025

Related U.S. Application Data
(63) Continuation of application No. PCT/CN2024/072005, filed on Jan. 12, 2024.

(30) Foreign Application Priority Data
Jan. 13, 2023 (CN) 202310078304.9

(51) Int. Cl. H04W 36/08; H04W 36/00; H04W 36/32

(52) U.S. Cl. CPC H04W 36/08; H04W 36/0058; H04W 36/008355; H04W 36/32

(57) ABSTRACT

This application provides a mobility management method and a communication apparatus, which may be applied to a non-terrestrial network, for example, a satellite network, an uncrewed aerial vehicle platform, or a high-altitude platform, and are used for performing mobility management triggered mainly by network mobility on a terminal. In the method, a feature in which terminal groups for which handover/reselection is to be performed have a same source node, a same destination node, same mobility management-related context information, and the like in the mobility management triggered mainly by the network mobility is used, so that signaling transmitted between the source node and the destination node may be in a signaling format of common part information of the terminal groups for which handover/reselection is to be performed and dedicated part information of each terminal in the terminal groups.

### CROSS-REFERENCE TO RELATED APPLICATIONS

This application is a continuation of International Application No. PCT/CN2024/072005, filed on Jan. 12, 2024, which claims priority to Chinese Patent Application No. 202310078304.9, filed on Jan. 13, 2023. The disclosures of the aforementioned applications are hereby incorporated by reference in their entireties.

### TECHNICAL FIELD

Embodiments of this application relate to the field of non-terrestrial communication technologies such as a satellite network, and more specifically, to a mobility management method and a communication apparatus.

### BACKGROUND

In a non-terrestrial network (for example, a beam hopping satellite communication system), movement of a satellite node causes a group handover (for a UE in a connected state) or group reselection (for a UE in an idle state) of a user equipment (UE) in a zone. However, an existing NR or non-terrestrial network (NTN) cell handover/cell reselection solution is usually designed based on cell handover/cell reselection triggered mainly by UE mobility.

In a low earth orbit (LEO) scenario, if group handover/group reselection is triggered mainly by mobility of a network (for example, a satellite), a large amount of information needs to be exchanged between a source node and a destination node, for example, between satellites, between a satellite and a core network, or between a distributed unit (DU) and a central unit (CU) of a satellite. For example, a single satellite covers 1.72×10⁶ square kilometers, and average service time is 5 minutes (that is, 300 seconds). It is assumed that there are 10 UEs (there are at most 10⁶ UEs in 5G NR) in a radio resource control (RRC) connected state per square kilometer. Overheads of signaling (including signaling such as a handover request, a handover request acknowledgment, and an SN status transfer) that needs to be exchanged between satellites (to be specific, a source satellite and a destination satellite) caused by handover of a single UE are about 23 kbits, and in this case, estimated inter-satellite signaling overheads caused by the handover are about 1.34 Gbps. When service time of the single satellite becomes shorter, the inter-satellite signaling overheads can reach a maximum of several Gbps or even dozens of Gbps. The signaling overheads are extremely high.

### SUMMARY

This application provides a mobility management method and a communication apparatus, to reduce signaling overheads of mobility management in a dynamic network scenario.

According to a first aspect, a mobility management method is provided, applied to a non-terrestrial network. The method includes:

A first node sends a first message to a second node, where the first message is used for configuring the second node to perform mobility management on a terminal device in one or more zones corresponding to the first node, the first message includes common part information and dedicated part information, the common part information includes common information of the terminal device in the one or more zones, and the dedicated part information includes specific information of each terminal device in the one or more zones.

The first node receives, from the second node, an acknowledgment message for the first message.

In this technical solution, a feature in which terminal groups for which handover/reselection is to be performed have a same source node, a same destination node, same mobility management-related context information, and the like in the mobility management triggered mainly by the network mobility is used, so that signaling transmitted between the source node (namely, the first node) and the destination node (namely, the second node) may include common part information of the terminal groups for which handover/reselection is to be performed and dedicated part information of each terminal in the terminal groups. In this way, signaling overheads in a process of the mobility management triggered mainly by the network mobility can be reduced.

In some embodiments, the method further includes:

The first node sends first information to the terminal device in the one or more zones, where the first information includes a service elevation angle corresponding to each of the one or more zones, the one or more zones include a first zone, an elevation angle of a terminal device in the first zone is greater than or equal to a service elevation angle corresponding to the first zone, and the first zone is any one of the one or more zones.

In this embodiment, a network side provides, to the terminal device, auxiliary information (namely, the first information) used for cell handover/reselection. The auxiliary information includes the service elevation angle of each of the one or more zones corresponding to the first node. For any zone (for example, the first zone) corresponding to the first node, the elevation angle of the terminal device in the zone needs to be greater than or equal to the service elevation angle corresponding to the zone. When the first node corresponds to a plurality of zones, the network side configures a corresponding service elevation angle for each zone, so that a terminal device in each zone can perform cell handover/reselection based on a longest service time criterion. In this way, frequency of the cell handover/reselection is reduced, and the signaling overheads in the mobility management process are further reduced.

In an embodiment, if the first node corresponds to the plurality of zones, when the network side configures service elevation angles of the plurality of zones, service elevation angles of at least some zones (for example, two or more zones) are different from each other. In this way, cell handover/reselection discretization of the terminal device in the plurality of zones is achieved, to reduce handover load on the network side. For example, the service elevation angles of the plurality of zones are different from each other; or each of the plurality of zones corresponds to one service elevation angle, but some of the plurality of zones may correspond to a same service elevation angle.

It should be noted that in this application, the “elevation angle” and the “service elevation angle” need to be distinguished. It is known that, in a satellite network, an elevation angle is an included angle between a satellite and a horizon of a position of a terminal device.

In some embodiments, the method further includes:

The first node sends second information to the terminal device in the one or more zones, where the second information includes a mobility cause and a measurement configuration corresponding to the mobility cause, the mobility cause includes triggering based on terminal device mobility or triggering based on network mobility, the mobility cause of the triggering based on the terminal device mobility corresponds to a first measurement configuration, the mobility cause of the triggering based on the network mobility corresponds to a second measurement configuration, and a to-be-measured neighboring cell included in the first measurement configuration and a to-be-measured neighboring cell included in the second measurement configuration are different.

In this embodiment, the auxiliary information (namely, the first information) that is provided by the network side for the terminal device and that is used for cell handover/reselection further includes the mobility cause and the measurement configuration corresponding to the mobility cause. The mobility cause may include the triggering based on the terminal device mobility or the triggering based on the network mobility. The two different mobility causes respectively correspond to different measurement configurations. This mainly means that neighboring cell information included in the measurement configurations is different, the to-be-measured neighboring cells are different, or neighboring cell relationships are different. By distinguishing between the mobility causes, namely, the triggering mainly based on the terminal mobility and the triggering mainly based on the network mobility, and configuring the different neighboring cell information (or referred to as the neighboring cell information) for the terminal, a quantity of to-be-measured neighboring cells may be reduced in some cases, so that measurement overheads of a terminal are reduced.

According to a second aspect, a mobility management method is provided, applied to a non-terrestrial network. The method includes:

A second node receives a first message from a first node, where the first message is used by the second node to perform mobility management on a terminal device in one or more zones corresponding to the first node, the first message includes common part information and dedicated part information, the common part information includes common information of the terminal device in the one or more zones, and the dedicated part information includes specific information of each terminal device in the one or more zones.

The second node sends an acknowledgment message for the first message to the first node.

For beneficial technical effects of the second aspect, refer to the descriptions of the first aspect. Details are not described again.

In some embodiments, the first node includes a first satellite or a terrestrial station corresponding to the first satellite, and the second node includes a second satellite or a terrestrial station corresponding to the second satellite.

The common part information includes one or more of the following information:
an identifier of an interface application protocol between the first node and the second node, information about the one or more zones, a handover or reselection cause, a handover or reselection time period, identifiers of a source node and a destination node, an identifier of a target access and mobility management function AMF, an identifier of a target user plane function UPF, a handover or reselection priority, and a common measurement configuration.

The terminal device in the one or more zones includes a first terminal device, and specific information of the first terminal device includes one or more of the following information:
an identifier related to the first terminal device, session information of the first terminal device, security-related information of the first terminal device, capability-related information of the first terminal device, a specific measurement configuration of the first terminal device, position information of the first terminal device, and speed vector information of the first terminal device.

In this embodiment, layer 3 mobility management on a terminal side may be supported, and signaling overheads between different satellite base stations or between satellite-associated terrestrial base stations are reduced.

In some embodiments, the first node includes a distributed unit DU of a first satellite, and the second node includes a distributed unit DU of a second satellite.

The common part information includes one or more of the following information:
configuration information of a source node or a source cell, radio resource configuration information, a target DU common configuration in access stratum context information, and information about the one or more zones.

The terminal device in the one or more zones includes a first terminal device, and specific information of the first terminal device includes one or more of the following information:
capability information of the first terminal device and specific configuration information of the first terminal device.

In this embodiment, a requirement for a processing capability on a satellite side can be reduced, and mobility management signaling overheads between different associated satellite distributed units DUs on the terminal side can be reduced.

In some embodiments, the first node includes a first satellite transmission reception point TRP, and the second node includes a second satellite TRP.

The common part information includes one or more of the following information:
a common configuration of a source cell, ephemeris information corresponding to the first node, information about the one or more zones, a common measurement configuration, and timer information.

The terminal device in the one or more zones includes a first terminal device, and specific information of the first terminal device includes one or more of the following information:
a specific identifier of the first terminal device and terminal-level access configuration information.

For example, the first node and the second node in this embodiment serve a hyper cell.

In this embodiment, layer 1/layer 2 mobility management on the terminal side may be supported, and frequency of layer 3 mobility management and signaling overheads on the terminal side are further reduced.

In some embodiments, a source cell of the terminal device in the one or more zones is a hyper cell, and the first node and the second node serve the hyper cell.

The first message includes bottom layer configuration information used for mobility management of the terminal device in the one or more zones, and the bottom layer configuration information includes configuration information of a physical layer and/or a medium access control (MAC) layer.

In this embodiment, the technical solution provided in this application is applied to a hyper cell architecture. In a cell handover/reselection process, only a bottom layer (usually including the PHY layer and the MAC layer)—related configuration used for handover/reselection of the terminal device needs to be exchanged between the source node and the destination node, so that an amount of exchanged information can be reduced, and signaling overheads can be further reduced.

In some embodiments, the information about the one or more zones includes one or more of the following information:
a position reference point of each of the one or more zones, frequency information and/or polarization information corresponding to the one or more zones, a number of the one or more zones, partial bandwidth information corresponding to the one or more zones, a handover time period or a reselection time period corresponding to the one or more zones, and a timer corresponding to the one or more zones.

In some embodiments, the acknowledgment message for the first message includes the common part information of the terminal device in the one or more zones and the dedicated part information of each terminal device in the one or more zones.

In this embodiment, a signaling format of the common part information and the dedicated part information of each terminal device is used for the acknowledgment message for the first message, so that signaling overheads can be further reduced.

In some embodiments, one or more of the following formats are used for the first message:
Xn interface application protocol XnAP format
F1 interface application protocol F1AP format
next generation NG interface application protocol NGAP format
X2 interface application protocol X2AP

In this embodiment, a signaling format (for example, a format of the first message) for exchange between nodes provided in this application is applicable to a plurality of interfaces, for example, an Xn interface, an F1 interface, an NG interface, and an X2 interface. This can increase overheads of signaling exchange between these interfaces in a mobility management process of a non-terrestrial network.

According to a third aspect, a mobility management method is provided, applied to a non-terrestrial network. The method includes:

A terminal device obtains first information from a first node, where the first information includes a service elevation angle corresponding to each of one or more zones corresponding to the first node, the one or more zones include a first zone, an elevation angle of a terminal device in the first zone is greater than or equal to a service elevation angle corresponding to the first zone, and the first zone is any one of the one or more zones.

The terminal device determines a target cell based on the first information, where the target cell is used for cell handover or cell reselection.

In this technical solution, a network side (for example, the first node) provides, to the terminal device, auxiliary information (namely, the first information) used for cell handover/reselection. The auxiliary information includes the service elevation angle of each of the one or more zones corresponding to the first node. For any zone (for example, the first zone) corresponding to the first node, the elevation angle of the terminal device in the zone needs to be greater than or equal to the service elevation angle corresponding to the zone. When the first node corresponds to a plurality of zones, the network side configures a corresponding service elevation angle for each zone, so that a terminal device in each zone can select a target cell based on a longest service time criterion. This can reduce frequency of the cell handover/reselection, so that signaling overheads in a mobility management process are reduced.

In some embodiments, the first information further includes reference point vector information corresponding to the first node, and the reference point vector information includes position information that is of a subsatellite point and that separately corresponds to the first node in N different time, where N is an integer greater than 1.

In this embodiment, the auxiliary information (namely, the first information) provided by the network side for the terminal device further includes the reference point vector information corresponding to the first node, and is used by the terminal device to calculate remaining service time of a zone in which the terminal device is located with reference to a service elevation angle of the zone in which the terminal device is located, to perform neighboring cell measurement before the remaining service time of the zone ends, and perform cell handover/reselection.

In some embodiments, that the terminal device determines a target cell based on the first information includes:

The terminal device determines service duration of each of different neighboring cells based on the service elevation angle corresponding to each of the one or more zones and the reference point vector information.

The terminal device determines the target cell from the neighboring cells based on the service duration of each of the different neighboring cells, where service duration of the target cell is not less than service duration of any other neighboring cell.

In this embodiment, the terminal device determines the service duration of each of the different neighboring cells based on the first information provided by the network side, and selects a neighboring cell with longest service time as the target cell based on the longest service time criterion. This can reduce the frequency of the cell handover/reselection, so that signaling overheads of mobility management are reduced.

In some embodiments, the method further includes:

The terminal device determines, based on a position of the terminal device and the first information, remaining service time corresponding to the zone in which the terminal device is located.

The terminal device performs neighboring cell measurement within the remaining service time.

In this embodiment, the terminal device calculates, based on the position of the terminal device with reference to the reference point vector information included in the first information and the service elevation angle corresponding to the zone in which the terminal device is located, the remaining service time corresponding to the zone in which the terminal device is located, and performs neighboring cell measurement within the remaining service time.

According to a fourth aspect, a mobility management method is provided, applied to a non-terrestrial network. The method includes:

A terminal device obtains second information from a first node, where the second information includes a first mobility cause and a measurement configuration corresponding to the first mobility cause, the first mobility cause is one of triggering based on terminal device mobility and triggering based on network mobility, the triggering based on the terminal device mobility corresponds to a first measurement configuration, the triggering based on the network mobility corresponds to a second measurement configuration, and a to-be-measured neighboring cell included in the first measurement configuration and a to-be-measured neighboring cell included in the second measurement configuration are different.

The terminal device performs neighboring cell measurement based on the second information.

In this technical solution, auxiliary information (namely, the second information) that is provided by a network side for the terminal device and that is used for cell handover/reselection includes the mobility cause and the measurement configuration corresponding to the mobility cause. The mobility cause may include the triggering based on the terminal device mobility or the triggering based on the network mobility. The two different mobility causes respectively correspond to different measurement configurations. This mainly means that neighboring cell information (or neighboring cell relationships) included in the measurement configurations is different. By distinguishing between the mobility causes, namely, the triggering mainly based on the terminal mobility and the triggering mainly based on the network mobility, and configuring the different neighboring cell relationships for the terminal, a quantity of to-be-measured neighboring cells may be reduced in some cases. This helps reduce measurement overheads of the terminal device.

In some embodiments, that the terminal device performs neighboring cell measurement based on the second information includes:

The terminal device determines, based on the second information, the measurement configuration corresponding to the first mobility cause.

The terminal device performs neighboring cell measurement based on the measurement configuration corresponding to the first mobility cause.

In this embodiment, the terminal device performs neighboring cell measurement based on a measurement configuration corresponding to a mobility cause for triggering a current neighboring cell measurement. This helps reduce the quantity of to-be-measured neighboring cells and reduce the measurement overheads of the terminal device.

According to a fifth aspect, this application provides a communication apparatus. In a design, the communication apparatus may include modules that are in one-to-one correspondence with and that are configured to perform the methods/operations/steps/actions described in the first aspect or the second aspect. The module may be a hardware circuit, may be software, or may be implemented by a hardware circuit in combination with software. In a design, the communication apparatus may include a processing module and a communication module.

According to a sixth aspect, this application provides a communication apparatus. In a design, the communication apparatus may include modules that are in one-to-one correspondence with and that are configured to perform the methods/operations/steps/actions described in the third aspect or the fourth aspect. The module may be a hardware circuit, may be software, or may be implemented by a hardware circuit in combination with software. In a design, the communication apparatus may include a processing module and a communication module.

According to a seventh aspect, this application provides a communication apparatus. The communication apparatus includes a processor, configured to implement the method according to any one of the first aspect, the second aspect, or the implementations of the first aspect or the second aspect. The processor is coupled to a memory. The memory is configured to store instructions and data. When the processor executes the instructions stored in the memory, the method according to any one of the first aspect, the second aspect, or the implementations of the first aspect or the second aspect can be implemented. In an embodiment, the communication apparatus may further include the memory. In an embodiment, the communication apparatus may further include a communication interface. The communication interface is used by the apparatus to communicate with another device. For example, the communication interface may be a transceiver, a hardware circuit, a bus, a module, a pin, or another type of communication interface. In an example, the communication apparatus may be a network device, for example, an access network device, may be an apparatus, a module, a chip, or the like disposed in the network device, or may be an apparatus that can be used in combination with the network device.

According to an eighth aspect, this application provides a communication apparatus. The communication apparatus includes a processor, configured to implement the method according to any one of the third aspect, the fourth aspect, or the implementations of the third aspect or the fourth aspect. The processor is coupled to a memory. The memory is configured to store instructions and data. When the processor executes the instructions stored in the memory, the method according to any one of the third aspect, the fourth aspect, or the implementations of the third aspect or the fourth aspect can be implemented. In an embodiment, the communication apparatus may further include the memory. In an embodiment, the communication apparatus may further include a communication interface. The communication interface is used by the apparatus to communicate with another device. For example, the communication interface may be a transceiver, a hardware circuit, a bus, a module, a pin, or another type of communication interface. In an example, the communication apparatus may be a terminal device, may be an apparatus, a module, a chip, or the like disposed in the terminal device, or may be an apparatus that can be used in combination with the terminal device.

According to a ninth aspect, this application provides a communication system, including a first node and a second node. In an embodiment, a terminal device is further included.

According to a tenth aspect, this application further provides a computer program. When the computer program is run on a computer, the computer is enabled to perform the method provided in any one of the first aspect to the fourth aspect or the implementations of the first aspect to the fourth aspect.

According to an eleventh aspect, this application further provides a computer program product, including instructions. When the instructions are run on a computer, the computer is enabled to perform the method provided in any one of the first aspect to the fourth aspect or the implementations of the first aspect to the fourth aspect.

According to a twelfth aspect, this application further provides a computer-readable storage medium. The computer-readable storage medium stores a computer program or instructions. When the computer program or the instructions are run on a computer, the computer is enabled to perform the method provided in any one of the first aspect to the fourth aspect or the implementations of the first aspect to the fourth aspect.

According to a thirteenth aspect, this application further provides a chip. The chip is configured to read a computer program stored in a memory, to perform the method provided in any one of the first aspect to the fourth aspect or the implementations of the first aspect to the fourth aspect; or the chip includes a circuit configured to perform the method provided in any one of the first aspect to the fourth aspect or the first aspect to the fourth aspect.

According to a fourteenth aspect, this application further provides a chip system. The chip system includes a processor, configured to support an apparatus in implementing the method provided in any one of the first aspect to the fourth aspect or the implementations of the first aspect to the fourth aspect. In a possible design, the chip system further includes a memory, and the memory is configured to store a program and data that are necessary for the apparatus. The chip system may include a chip, or may include a chip and another discrete component.

For technical effects of the solutions provided in any one of the fifth aspect to the fourteenth aspect or the implementations of the fifth aspect to the fourteenth aspect, refer to the corresponding descriptions in the first aspect. Details are not described again.

### BRIEF DESCRIPTION OF DRAWINGS

FIG. 1 is a diagram of a beam hopping satellite communication system according to some embodiments of this application;

FIG. 2 is a diagram of a group handover problem in a beam hopping satellite communication system;

FIG. 3 is a diagram of a satellite communication system applicable to an embodiment of this application;

FIG. 4 is a schematic flowchart of a mobility management method according to some embodiments of this application;

FIG. 5 is a diagram of group handover according to some embodiments of this application;

FIG. 6 shows an example of a format of a first message according to some embodiments of this application;

FIG. 7 is a schematic flowchart of applying a mobility management method to F1AP PDU enhancement according to some embodiments of this application;

FIG. 8 shows an example of a satellite hyper cell architecture according to some embodiments of this application;

FIG. 9 shows a control plane protocol stack when a mobility management method according to some embodiments of this application is applied to hyper cell-based inter-satellite handover;

FIG. 10 shows an example of a mobility management method according to some embodiments of this application;

FIG. 11 is a diagram of a neighboring cell relationship based on a longest service time criterion according to some embodiments of this application;

FIG. 12 shows an example of a mobility management method according to some embodiments of this application;

FIG. 13 is a diagram of a communication apparatus 1000 according to some embodiments of this application; and

FIG. 14 is a diagram of a communication apparatus 1100 according to some embodiments of this application.

### DESCRIPTION OF EMBODIMENTS

The following describes technical solutions of this application with reference to accompanying drawings.

For ease of understanding the technical solutions of this application, concepts or related technologies in the solutions are first briefly described.

### 1. Beam Position

A service zone of a satellite network is divided into a plurality of small geographical zones based on geographical positions, and each geographical zone may be referred to as a beam position. In an embodiment, the beam position in this application may be alternatively represented as a geographical zone, a zone, a service zone, or the like. For example, a beam position corresponding to a first node is a geographical zone, a zone, or a service zone corresponding to the first node.

### 2. Xn Interface

The Xn interface is an interface between base stations. This application includes an interface between base stations of different standards, for example, an interface between an LTE base station, a 5G base station, a beyond 5G base station, or a satellite base station and a terrestrial base station.

### 3. Non-Terrestrial Network (NTN)

The non-terrestrial network includes nodes such as a satellite network, a high-altitude platform, and an uncrewed aerial vehicle, has significant advantages such as global coverage, long-distance transmission, flexible networking, easy deployment, and being not limited by geographical conditions, and has been widely applied to a plurality of fields such as maritime communication, positioning and navigation, disaster relief, scientific experiments, video broadcasting, and earth observation. A terrestrial 5G network, the satellite network, and the like are integrated, to gather strengths and overcome a weakness, jointly form an integrated communication network that provides seamless global coverage by sea, land, air, space, and ground, and satisfy a plurality of ubiquitous service requirements of users.

As an important part of the NTN, a next-generation satellite network generally has a trend of being ultra dense and heterogeneous. First, a scale of the satellite network develops from 66 satellites in an Iridium satellite constellation to 720 satellites in a Oneweb satellite constellation, and finally develops to 12000+ satellites in a Starlink ultra dense LEO satellite constellation. Second, the satellite network has a heterogeneous feature, and develops from a conventional single-layer communication network to a multi-layer communication network. A communication satellite network tends to have complex and diversified functions, and is gradually compatible with and supports functions such as navigation enhancement, earth observation, and on-orbit processing of multi-dimensional information.

### 4. Beam Hopping Communication Technology

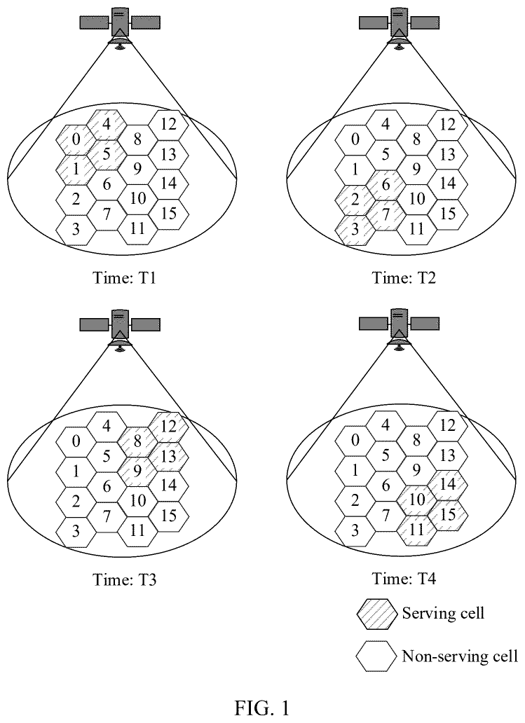

Generally, a single satellite has an extremely wide coverage zone, which may reach thousands or even tens of thousands of kilometers, and a single beam has a minimum coverage zone of dozens or even thousands of meters. Therefore, to support wide-zone coverage, hundreds or even thousands of beams usually need to be configured for the single satellite. This poses a great challenge to load of the satellite (especially an LEO satellite). To alleviate a contradiction between low load and the wide coverage zone of the single satellite, a beam hopping satellite communication system emerges correspondingly. Specifically, in the beam hopping satellite system, only a few beams (for example, dozens of beams) are configured for the single satellite, and the beams serve all coverage zones of the single satellite in a time division manner. Refer to a beam hopping satellite communication system shown in FIG. 1. As shown in FIG. 1, a satellite can form only four beams at a same moment. At a time T1, four beams 0, 1, 4, and 5 are used for covering zones (namely, beam positions) corresponding to the four beams; and at a time T2, four beams 2, 3, 6, and 7 are used for covering zones corresponding to the four beams. The rest may be deduced by analogy. All zones (that is, zones corresponding to 16 beams) covered by the single satellite are served in a time division manner of T1, T2, T3, and T4.

### 5. Mobility Management Problem

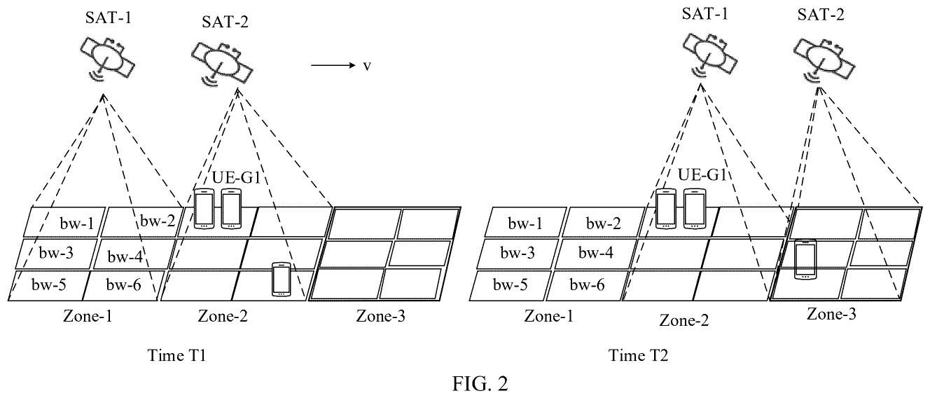

Movement of a satellite node causes group handover (a UE in connected state) or group reselection (a UE in an idle state) that occurs on a UE in a beam position in a zone. Group handover shown in FIG. 2 is used as an example. A UE cluster in a single beam position in a zone Zone-2, for example, a UE-Group1, is briefly denoted as a UE-G1 (the UE-G1 includes a plurality of UEs). At time T1, the UE-G1 is served by one or more beams of a satellite SAT-2; and at time T2, movement of the satellite SAT-2 causes a case in which the beam position cannot be served, and one or more beams of a satellite SAT-1 replace that of the satellite SAT-2 to serve the UE-G1. Therefore, group handover occurs on the UE-G1. In addition, because the satellite moves at a high speed of about 7.5 km/s, frequency of the group handover is about once/several seconds to dozens of seconds. In other words, in a beam hopping LEO satellite network, group handover triggered mainly by network mobility becomes a normal phenomenon.

Mobility management mainly includes cell handover, cell reselection, and the like. Using the cell handover as an example, a handover procedure of a terrestrial network mainly includes the following operations.

(1) Cell handover measurement: Generally, a network delivers, to a UE, measurement configurations corresponding to a plurality of cells (including a serving cell and a neighboring cell), and the UE measures cell signal quality, such as reference signal received power (RSRP) and reference signal received quality (RSRQ), based on the measurement configurations.

(2) Measurement result reporting: The UE reports a measurement result to the network. A reporting manner may be periodic reporting, event-triggered reporting, or the like. In the event-triggered reporting, a reporting condition is generally configured as follows: Signal quality of the serving cell is lower than a threshold 1 and/or signal quality of the neighboring cell is higher than a threshold 2.

(3) Handover decision: A network side selects an appropriate neighboring cell based on the reported result, and exchanges information such as UE handover-related context information, admission control, and reserved resources.

(4) Handover execution: The UE receives handover-related control information from the serving cell, and completes an access procedure in a destination cell.

A random access preamble required by the UE during the handover is a specific preamble, which is different from a contention-based random access preamble during initial access. In addition, a configuration supported by a time domain periodicity of a random access channel (RACH) during the handover is 10/20/40/80/160 ms, which is the same as a configuration of a RACH periodicity during the initial access.

For cell reselection, the network generally delivers, to the UE in a broadcast manner, parameters such as a measurement configuration related to the neighboring cell. The UE compares a measurement value (such as RSRQ and RSRP) of the UE with the parameter (such as a reselection threshold) and the like delivered by the network, and performs autonomous reselection to a target neighboring cell after a condition is satisfied. It should be noted that, because a near-far effect in an NTN is not definite, efficiency of the handover/reselection triggered only by the signal quality is low. Therefore, a position-assisted handover/reselection enhancement technology is considered for the NR/NTN. For example, mobility management in the NTN network is implemented based on a plurality of manners such as time/a timer, UE position information (for example, a distance between the UE and a reference point of a source cell is greater than a threshold 1, and a distance between the UE and a reference point of a target cell is less than a threshold 2) and a timer, and a combination of a position and signal quality.

However, an existing NR and NTN handover/reselection solution is usually designed based on handover/reselection triggered mainly by UE mobility. In an LEO scenario, in a mode in which group handover/group reselection is triggered mainly by the mobility of the network (for example, a satellite), a large amount of information needs to be exchanged between base stations (or between satellites, or between a satellite and a core network, or between a DU and a CU of a satellite).

Therefore, for the mobility management problem (which may specifically include the cell handover and/or cell reselection) in the beam hopping LEO satellite network, this application proposes an efficient mobility management method by using a group handover feature in the LEO beam hopping satellite network, to reduce signaling overheads of mobility management in a dynamic network scenario.

The technical solutions of this application may be applied to a non-terrestrial network (NTN) system such as a satellite communication system, a high-altitude platform (for example, high-altitude platform station, HAPS) communication system, or an uncrewed aerial vehicle, for example, an integrated communication and navigation (IcaN) system, a global navigation satellite system (GNSS), and an ultra-dense low-orbit satellite communication system. The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system, a 6th generation (6G) communication system, a possibly applicable future mobile communication system, and the like.

The satellite communication system includes a UE and a network device. The UE may also be referred to as a user terminal, a terminal, a terminal device, a mobile station, or the like. The network device may include one or more satellites and one or more terrestrial station devices. The terrestrial station device may also be referred to as a core network device. The satellite may be an LEO satellite, a non-geostationary orbit (also called, non-geostationary earth orbit, NGEO) satellite, or the like. This is not limited.

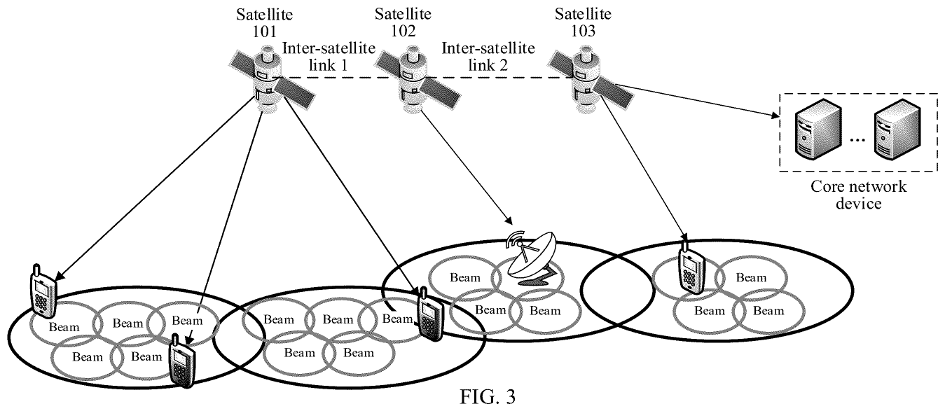

FIG. 3 is a diagram of a satellite communication system applicable to an embodiment of this application. The satellite communication system includes a satellite 101, a satellite 102, and a satellite 103. Each satellite may provide a service, for example, a communication service, a navigation service, and a positioning service, for a terminal device by using a plurality of beams. In this scenario, the satellite is an LEO satellite. The satellite 103 is connected to a terrestrial station device. The satellite uses a plurality of beams to cover a service zone, and different beams may be used for performing communication in one or more manners of time division, frequency division, and space division. The satellite performs wireless communication with the terminal device by using a broadcast communication signal, a navigation signal, and the like. Satellites can wirelessly communicate with the terrestrial station device.

In addition, the satellite communication system may include a transparent transmission satellite architecture and a non-transparent transmission satellite architecture. Transparent transmission is also referred to as bent-pipe forwarding transmission. To be specific, only processes such as frequency conversion and signal amplification are performed on a signal on a satellite, and the satellite is transparent to the signal as if the satellite does not exist. Non-transparent transmission is also referred to as regenerative (on-satellite access/processing) transmission. That is, the satellite has some or all of functions of a base station. For example, the satellite 101 and the satellite 102 in FIG. 3 are in the non-transparent transmission satellite architecture, and the satellite 103 is in the transparent transmission satellite architecture. In addition, the satellite may work in a quasi earth-fixed mode or a satellite-fixed mode.

The terminal device mentioned in embodiments of this application includes various communication kits (communication kits, where the kit may include, for example, an antenna, a power supply template, a cable, and a Wi-Fi module) having a wireless communication function, a handheld device, a vehicle-mounted device, or another processing device connected to a wireless modem, and may specifically be a user equipment (UE), an access terminal, a subscriber unit, a subscriber station, a mobile station, a remote station, a remote terminal, a mobile device, a user terminal, a terminal, a wireless communication device, a user agent, or a user apparatus. Alternatively, the terminal device may be a communication module having a satellite communication function, a satellite phone or a component thereof, a very small aperture terminal (VSAT), a wireless modem, a machine type communication device, or another processing device connected to a wireless modem. Alternatively, the terminal device may be a virtual reality (VR) terminal device, an augmented reality (AR) terminal device, a wireless terminal in industrial control, a terminal in self driving, a terminal in telemedicine (also called, remote medical), a terminal in a smart grid, a terminal in transportation safety, a terminal in a smart city, a terminal in a smart home, a terminal device in a future communication network, or the like. Certainly, the terminal device in this application may alternatively be a chip, a modem, a system on a chip (SoC), or a communication platform that may include a radio frequency RF part or the like, which are mainly responsible for a related communication function in the device.

The terrestrial station device may be a device in a core network (CN) in an existing mobile communication architecture (for example, a 3rd generation partnership project (3GPP) access architecture of a 5G network), a device in a core network in a future mobile communication architecture, a device used for connecting a satellite and a core network, or a relay device used for satellite communication. As a bearer network, the core network provides an interface to a data network, provides communication connection, authentication, management, and policy control for a UE, bears a data service, and the like. The CN may further include network elements such as an access and mobility management function (AMF), a session management function (SMF), an authentication server function (AUSF), a policy control function (PCF), and a user plane function (UPF) network element. The AMF network element is configured to manage access and mobility of the UE, and is mainly responsible for functions such as UE authentication, UE mobility management, and UE paging.

The network device may further include but is not limited to: an evolved NodeB (eNB), a baseband unit (BBU), an access point (AP) in a wireless fidelity (Wi-Fi) system, a wireless relay node, a wireless backhaul node, a transmission point (TP), a transmission reception point (TRP), or the like. Alternatively, the network device may be a gNB, a TRP, or a TP in a 5G system, or one or a group of antenna panels (including a plurality of antenna panels) of a base station in a 5G system. In addition, the network device may alternatively be a network node that forms a gNB or a TP, for example, a BBU or a distributed unit (DU). Alternatively, the network device may be a device that undertakes a network side function and that is in a device-to-device (D2D) communication system, a machine-to-machine (M2M) communication system, an internet of things (IoT), an internet of vehicles communication system, or another communication system.

The satellite mentioned in embodiments of this application may be an LEO satellite, a medium orbit earth (MEO) satellite, an earth synchronous orbit (also called, geostationary earth orbit, GEO) satellite, or the like.

In an embodiment, the satellite mentioned in embodiments of this application may be a satellite base station, may include an orbit receiver or a repeater configured to relay information, may be a network side device mounted on a satellite, or the like.

The following describes in detail a mobility management method provided in this application.

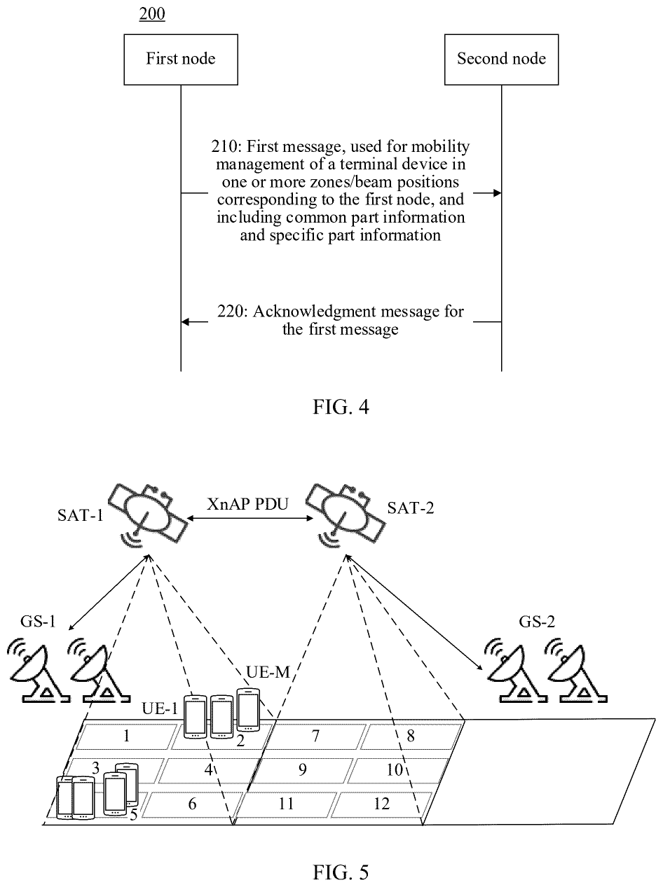

FIG. 4 is a schematic flowchart of a mobility management method according to this application. The method 200 may be applied to mobility management of a terminal device in a non-terrestrial network.

Operation 210: A first node sends a first message to a second node, where the first message is used for mobility management of a terminal device in one or more zones corresponding to the first node.

The first message includes common part information and dedicated part information, the common part information includes common information of the terminal device in the one or more zones, and the dedicated part information includes specific information of each terminal device in the one or more zones.

It should be understood that the common part information and the dedicated part information are for a terminal device, in the one or more zones, for which handover and/or reselection are/is to be performed. In a scenario in which cell handover/cell reselection is triggered mainly by network mobility, the terminal device, in the one or more zones, for which handover and/or reselection are/is to be performed is usually a group of terminal devices, which is briefly referred to as a terminal device group, a UE group, or the like. In other words, the common part information includes common information of the terminal device group, in the one or more zones, for which handover and/or reselection are/is to be performed, and the dedicated part information includes specific information of each terminal device in the terminal device group, in the one or more zones, for which handover and/or reselection are/is to be performed.

Operation 220: The first node receives, from the second node, an acknowledgment message for the first message.

In the method 200, the first node may be a source node for mobility management, and the second node is a destination node. For example, the first node is a source node for cell handover or cell reselection, and the second node is a destination node for cell handover or cell reselection.

In addition, the mobility management mentioned in this embodiment of this application may include cell handover and/or cell reselection. For example, a terminal device in the one or more zones performs cell handover, and a terminal device performs cell reselection.

In an embodiment, for the acknowledgment message, refer to a signaling format of the first message, and the acknowledgment message includes the common part information of the terminal device in the one or more zones and the dedicated part information of each terminal device. For example, in the acknowledgment message, information such as identifiers of a source cell, an identifier of a destination cell, and a handover time period/reselection time period is the same for the terminal device in the one or more zones, and may be used as the common part information; and information such as an identifier varies with each terminal device in the one or more zones, and is used as the dedicated part information of each terminal device.

In the technical solutions of this application, a feature in which terminals for which handover and/or reselection are/is to be performed have a same source node, a same destination node, same mobility management-related context information, and the like in the mobility management triggered mainly by the network mobility is used, so that information about the terminal devices for which handover and/or reselection are/is to be performed is divided into common part information and dedicated part information of each terminal device for signaling transmitted between the source node (namely, the first node) and the destination node (namely, the second node). In this way, signaling overheads in a process of the mobility management triggered mainly by the network mobility can be reduced.

In an embodiment, the first node in this embodiment of this application includes one or more of the following:
a first satellite, a terrestrial station (for example, a terrestrial base station) corresponding to the first satellite, a DU of the first satellite, and a first satellite TRP.

The second node includes one or more of the following:
a second satellite, a terrestrial station (for example, a terrestrial base station) corresponding to the second satellite, a DU of the second satellite, and a second satellite TRP.

The first satellite and the second satellite are two different satellites. The first satellite may be understood as a source satellite, and the second satellite may be understood as a destination satellite.

For example, the technical solutions provided in this application may be applied to XnAP PDU enhancement.

In this example, the first node is the first satellite or the terrestrial station connected to the first satellite, and the second node is the second satellite or the terrestrial station connected to the second satellite.

FIG. 5 is a diagram of group handover.

As shown in FIG. 5, a satellite system includes satellite nodes (SAT-1 and SAT-2), terrestrial beam positions (where beam position numbers are 1 to 12), and terrestrial stations (GS-1 and GS-2), and the like. A first message used for mobility management of UEs (for example, a UE 1 to a UE-M in a beam position 2) in one or more beam positions (for example, a beam position 2 and a beam position 5) is exchanged between satellites (or between a satellite and a terrestrial station, or between terrestrial station nodes). For example, the first message is an XnAP PDU. The XnAP PDU includes header information XnAP header, common part information (namely, XnAP common part information), and UE-dedicated part information (namely, an XnAP UE-specific part information), as shown in FIG. 6. It should be noted that the existing XnAP PDU includes only the XnAP header and information related to a single UE, where the information related to the single UE includes an XnAP identifier of the UE, a handover or reselection cause, an RRC context, a frequency/access site priority, a UE security capability, UE security information, and the like. It should be understood that a sequence of the information elements in FIG. 6 is merely an example, and the sequence may be adjusted, and is not limited to a form presented in FIG. 6.

The common part information includes one or more of the following:
an identifier of an interface application protocol (for example, an XnAP) between a first node and a second node, information about one or more zones corresponding to the first node, a handover or reselection cause, a handover or reselection time period, an identifier of a source cell or a source node, an identifier of a destination cell or a destination node, an identifier of a target access and mobility management function (AMF), an identifier of a target user plane function (UPF), a handover or reselection priority, and a common measurement configuration.

For example, common measurement configuration information includes a synchronization signal block (SSB)-based measurement timing configuration (SMTC), an SMTC offset, measurement gap information, and the like.

Using a first terminal in the one or more zones corresponding to the first node as an example, dedicated part information of the first terminal includes one or more of the following: an identifier related to the first terminal device, session information of the first terminal device, security-related information of the first terminal device, capability-related information of the first terminal device, a specific measurement configuration of the first terminal device, position information of the first terminal device, and speed vector information of the first terminal device.

For example, the specific measurement configuration includes, for example, an SMTC, an SMTC offset, and measurement gap information. Specifically, the specific measurement configuration may be the SMTC, the SMTC offset, and a measurement gap that are provided in the common measurement configuration plus an offset (which may be 0).

In addition, the information about the one or more zones corresponding to the first node may include one or more of the following:
a position reference point of each of the one or more zones, frequency and/or polarization information corresponding to the one or more zones, a number of the one or more zones, partial bandwidth information corresponding to the one or more zones, a handover time period or a reselection time period corresponding to the one or more zones, and a timer corresponding to the one or more zones. For example, a handover timer represents a deadline of zone handover.

A specific exchange process is as follows:

The source node compresses information of the UE, in the one or more covered zones (or referred to as beam positions), for which handover and/or reselection are/is to be performed (that is, group information), packs the information into an XnAP PDU, and sends the XnAP PDU to the destination node.

The destination node receives the XnAP PDU from the source node, processes the XnAP PDU locally or forwards the XnAP PDU to a core network for processing, and returns an acknowledgment message for the XnAP PDU to the source node after processing.

It should be noted that the XnAP is merely an example. Messages used for mobility management on interfaces such as an NGAP, an F1AP, and an X2AP may also be enhanced by using the method provided in this application. In other words, a format of “common part information+dedicated part information” may be used for each of the messages used for mobility management on the interfaces.

For example, the technical solutions provided in this application may be applied to F1AP PDU enhancement.

In this example, a first node may be a DU of a first satellite, and a second node may be a DU of a second satellite.

In a known CU-DU separation architecture, mobility management-related signaling is exchanged by using the DU and the CU, and direct exchange between the DU and the DU is not supported. In a satellite network, because a propagation delay from a satellite DU to a terrestrial station CU node is large, an interface between DUs is added, to implement fast and efficient communication between satellite nodes (or between a satellite and a terrestrial station, or between terrestrial stations). In an embodiment, an XnAP interface protocol or an F1AP interface protocol may be reused for an interface protocol between the DUs, to transfer mobility management-related information, for example, handover preparation information (namely, HandoverPreparationInformation) and a DU handover (namely, DU handover) message. The mobility management-related information/message may be in the signaling format of the common part information+the dedicated part information.

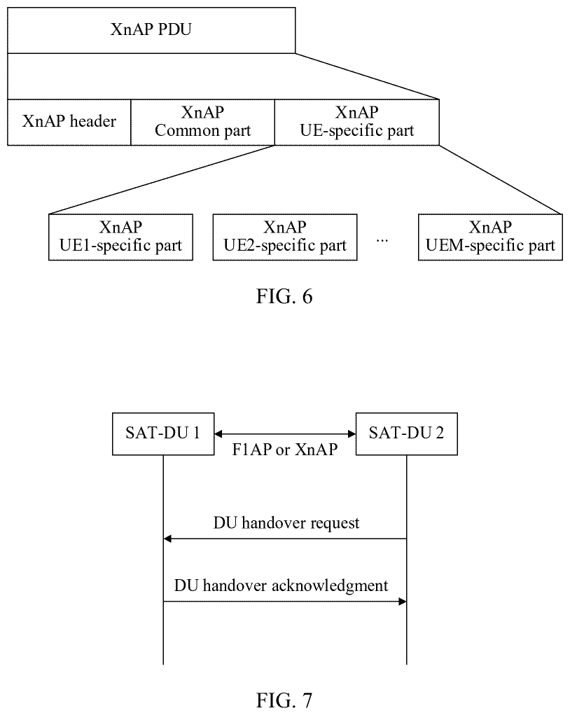

An exchange process may be shown in FIG. 7.

Source node: compresses the mobility management-related information (for example, a handover request message) of the UE, in the one or more zones covered by the source node, for which handover and/or reselection are/is to be performed, packs the mobility management-related information into an F1AP or XnAP format, for example, an F1AP/XnAP PDU (an example of the first message), and sends the F1AP/XnAP PDU to the destination node.

Destination node: receives the F1AP/XnAP PDU from the source node, processes the F1AP/XnAP PDU locally or forwards the F1AP/XnAP PDU to the core network for processing, and returns an acknowledgment message (DU handover acknowledge) for the F1AP/XnAP PDU to the source node after processing. In an embodiment, for composition of the acknowledgment message, refer to the signaling format of the common part information and the dedicated part information.

In this example, the common part information may include one or more of the following information:
configuration information (sourceConfig) of the source node/a source cell, radio resource configuration information (rrc-config), a target DU common configuration in access stratum context information (as-context), and information about the one or more zones corresponding to the first node. The information about the one or more zones includes a random access channel occasion (RACH occasion, RO) configuration, an ephemeris message, and the like. The RO configuration includes, for example, information such as a handover time period/reselection time period.

Using a first terminal in the one or more zones corresponding to the first node as an example, dedicated part information of the first terminal includes one or more of the following information:

UE capability information (for example, configured as an ue-CapabilityRAT-List information element) and a UE-specific configuration (for example, a handover preamble and a UE-level inactive timer ue-InactiveTime).

For example, the technical solutions provided in this application may be applied to mobility management of a terminal device based on a hyper cell.

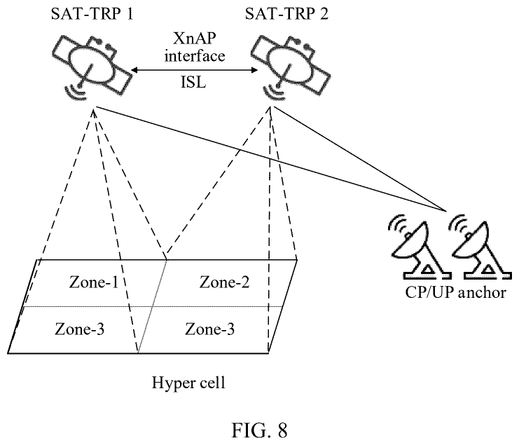

FIG. 8 shows an example of a satellite hyper cell architecture. As shown in FIG. 8, one terrestrial control node (for example, a CP/UP anchor) is responsible for one hyper cell (HyperCell). One hyper cell is served by two satellite TRPs (corresponding to a SAT-TRP 1 and a SAT-TRP 2). In an embodiment, the SAT-TRP 1 and the SAT-TRP 2 serve zones in the hyper cell in a space division manner. For example, the SAT-TRP 1 serves a zone 1 and a zone 2 (corresponding to a Zone-1 and a Zone-2), and the SAT-TRP 2 serves a zone 3 and a zone 4 (corresponding to a Zone-3 and a Zone-4). An inter-satellite link (ISL) is used between the SAT-TRP 1 and the SAT-TRP 2 for data forwarding and signaling exchange. One zone in FIG. 8 may correspond to one or more beam positions (in other words, zones or geographical zones corresponding to the beam positions).

In this example, when a UE does not move, the UE only needs to maintain hyper cell-specific (namely, HyperCell-specific) broadcast information or broadcast information that is specific to the zone in the hyper cell (Zone-specific in the hyper cell), and does not need to frequently update the broadcast information, to reduce signaling overheads.

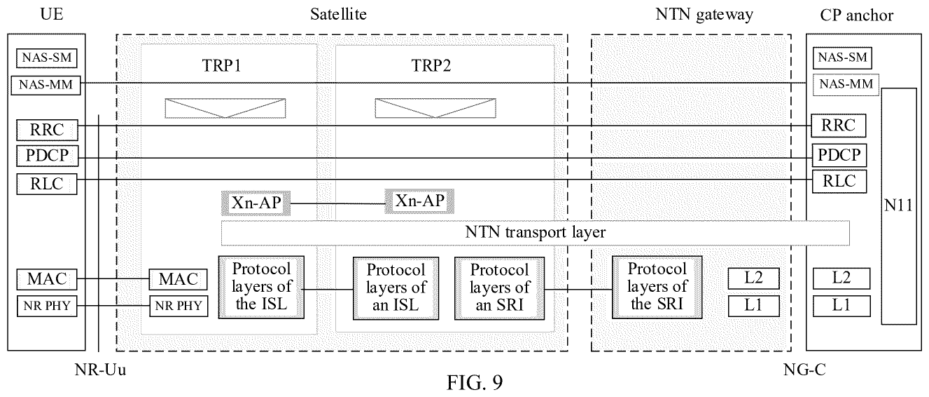

For a protocol stack corresponding to a control plane, refer to FIG. 9. For functions corresponding to each layer, refer to Table 1.

TABLE 1

| NR/NTN | |
|---|---|
| protocol | |
| stack | Function description |
| NAS | Is used for connection and mobility control between a |
| | UE and an AMF, and is transparent to a base station |
| PDU | Is used for data transmission between the UE and a UPF, |
| | and is transparent to the base station |
| RRC | Messages between the UE and the base station include |
| | a system message, admission control, security |
| | management, cell reselection, measurement reporting, |
| | handover and mobility, NAS message transmission, |
| | radio resource management, and the like |
| Service data | Is responsible for mapping between a quality of |
| adaptation | service (QoS) flow and a data radio bearer (DRB), |
| protocol | and adding a quality of service flow identifier |
| (SDAP) | (QFI) to a data packet |
| RLC | transparent mode (TM) (broadcast message), |
| | unacknowledged mode (UM) (voice service, with |
| | a delay requirement), acknowledged mode (AM) |
| | (common service, with high accuracy); |
| | segmentation and reassembly (for the UM/AM, |
| | where a size of a data packet obtained through |
| | segmentation is determined by MAC, and the size |
| | is large in a good radio environment, and is |
| | small in a poor radio environment); and error |
| | correction (only for the AM, an ARQ, with high |
| | accuracy) |
| Packet data | Is used for user-plane network interconnection |
| convergence | protocol (for example, internet protocol, IP) |
| protocol | header compression, encryption/decryption (control |
| (PDCP) | plane/user plane), control-plane integrity check |
| | (where there is only a control plane in 4G, and |
| | optional check may be performed on a 5G user |
| | plane), sorting and replication detection, |
| | and a routing function in non-standalone (NSA) |
| | networking |
| MAC | resource scheduling, mapping between a |
| | logical channel and a transport channel, |
| | multiplexing/demultiplexing, hybrid automatic |
| | repeat request (HARQ), and |
| | concatenation/segmentation |
| PHY | error detection, forward error correction |
| | (FEC), encryption and decryption, rate |
| | matching, physical channel mapping, adjustment |
| | and demodulation, frequency synchronization |
| | and time synchronization, wireless measurement, |
| | multiple-input multiple-output (MIMO) |
| | processing, and radio frequency processing |
| NTN transport | An IP-less transmission protocol is used for |
| layer | implementing fast L2 switching of control |
| (NTN-TL) | plane and user plane data |

In this example, a specific implementation is as follows:

A CP/UP anchor side: stores context information related to RLC/a packet data convergence protocol (PDCP)/RRC and non-access stratum (NAS)—session management (SM)/NAS-mobility management (/NAS-MIM) of the UE. When the UE does not move, the foregoing information generally does not need to be changed. When the UE moves beyond a management range of a CP/UP anchor, the context information needs to be exchanged between different CP/UP anchors. The CP/UP anchor needs to receive mobility management-related information transferred by a SAT-TRP as required, and returns an acknowledgment message after processing.

Source node: compresses the mobility management-related information (for example, configuration information of bottom layers such as the PHY and the MAC) of UE, in one or more zones covered by the source node, for which handover and/or reselection are/is to be performed, packs the mobility management-related information into an F1AP or XnAP format, for example, an F1AP/XnAP PDU (an example of a first message), and sends the F1AP/XnAP PDU to a destination node.

Destination node: receives the F1AP/XnAP PDU from the source node, processes the F1AP/XnAP PDU locally or forwards the F1AP/XnAP PDU to a core network (for example, the CP/UP anchor) for processing, and returns an acknowledgment message for the F1AP/XnAP PDU to the source node after processing. In an embodiment, for composition of the acknowledgment message, refer to the signaling format of the common part information and the dedicated part information.

In this example, optionally, common part information in the first message may include one or more of the following information:
a source cell common configuration (ServingCellConfigCommon), ephemeris information corresponding to a first node, information about one or more zones corresponding to the first node, a common measurement configuration, and timer information (for example, information about a timer t304).

For example, the information about the one or more zones corresponding to the first node may include one or more of the following:
a handover time period/reselection time period corresponding to each of the one or more zones, partial bandwidth information, frequency/polarization information, position reference point information, and the like corresponding to each of the one or more zones.

For example, the common measurement configuration may be one or more of an SMTC, an SMTC offset, and measurement gap information.

Using a first terminal device in the one or more zones corresponding to the first node as an example, dedicated part information of the first terminal device includes one or more of the following information:
a specific identifier of the first terminal device, where the specific identifier does not need to be changed in the hyper cell; and

UE-level access configuration information (namely, rach-configDedicated information) of the first terminal device, for example, preamble information.

In this example, a specific identifier of a UE in the hyper cell is not changed as the UE moves between different zones in the hyper cell. The hyper cell shown in FIG. 8 is used as an example. When a UE moves between different zones in the hyper cell, a specific identifier of the UE does not need to be changed. The specific identifier of the UE needs to be changed only when the UE moves out of the hyper cell.

It should be noted that, in this example, because the context information of the UE is stored in the CP/UP anchor, when a movement range of the UE is small (for example, does not exceed a threshold), the context information does not need to be changed. Therefore, only configuration information related to the bottom layers (that is, the PHY layer and the MAC layer) needs to be exchanged between SAT-TRPs or between the SAT-TRP and the CP/UP anchor.

The technical solutions of this application are applied to the architecture in the foregoing example. When mobility management is performed on the UE in the one or more zones corresponding to the source node, a signaling format of common part information+dedicated part information is used for signaling exchange (for example, the first message and the acknowledgment message for the first message) between the source node and the destination node, so that signaling overheads can be reduced.

Based on the foregoing example, this application further provides some other solutions of the mobility management method. These solutions may also reduce signaling overheads in a process of UE mobility management triggered mainly by network mobility, or help reduce measurement overheads on a terminal side in the process of the mobility management triggered mainly by the network mobility.

It should be noted that, the other solutions provided below may be separately applied, or may be used in combination; the other solutions provided below may be separately used in combination with any one of the foregoing examples; or the other solutions provided below may be used in combination with any one of the foregoing examples on the basis of combining the other solutions provided below. It should be understood that, in these solutions used in combination, a technical effect of reducing signaling overheads is a superposition of technical effects of all the examples. For example, a combination of two solutions for reducing signaling overheads enables technical effects of reducing signaling overheads in the solutions to be superimposed. In comparison with using a single solution, signaling overheads of mobility management can be reduced to a greater extent. In addition, if a method for reducing signaling overheads is combined with a solution for reducing measurement overheads on a terminal side, the signaling overheads are reduced, and the measurement overheads on a terminal side are further reduced.

For example, this application further provides a method for performing mobility management (for example, handover/reselection) based on longest service duration, to reduce frequency of the handover/reselection. In this way, signaling overheads of the mobility management are reduced.

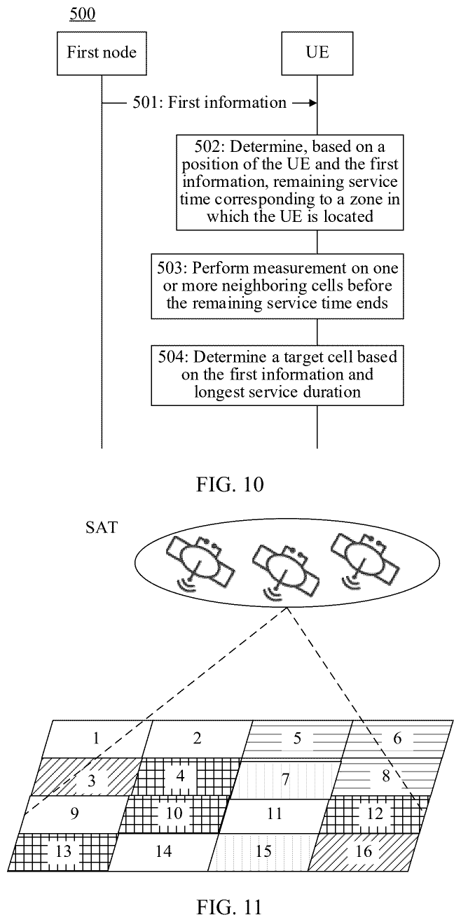

FIG. 10 shows an example of a mobility management method according to this application.

Operation 501: A first node sends first information to a terminal device in one or more zones corresponding to the first node.

The first information is used by the terminal device to determine service time corresponding to each of the one or more zones. Specifically, the first information may include a service elevation angle corresponding to each of the one or more zones. The one or more zones include a first zone, and an elevation angle of a terminal device in the first zone is greater than or equal to a service elevation angle corresponding to the first zone. The first zone is any one of the one or more zones.

It should be understood that the service elevation angle needs to be distinguished from the elevation angle (or referred to as a physical elevation angle) of the terminal device. The service elevation angle is delivered by a network side to the terminal device to implement progressive group handover/group reselection for the terminal device in a plurality of zones corresponding to the first node. For a zone, a service elevation angle of the zone delivered by the network side is less than an elevation angle of a terminal device in the zone.

In an embodiment, the first node may send the first information to the UE in the one or more zones in a unicast or broadcast manner. When the first node corresponds to a plurality of zones, at least some zones correspond to different service elevation angles. For example, each of two or more zones corresponds to a different service elevation angle. In a specific example, gama_01 is configured in a zone 1 (or a beam position 1), and gama_02 is configured in a zone 2 (or a beam position 2) and a zone 3 (or a beam position 3), so that mobility management of UEs in different zones corresponding to the first node can be discretized. By configuring the service elevation angle corresponding to each of the plurality of zones corresponding to the first node, an effect of the progressive group handover/group reselection of the UE in the plurality of zones can be achieved.

Further, the first information further includes reference point vector information corresponding to the first node, and the reference point vector information includes position information that is of a subsatellite point and that separately corresponds to the first node in N different time, where N is an integer greater than 1.

It should be understood that the subsatellite point may be generally understood as a projection of a satellite on the ground. Due to satellite mobility, the first node corresponds to different subsatellite point positions at different time. For example, the reference point vector information may be represented as {(lon1, lat1), (lon2, lat2), . . . , and (lonN, latN)}. The reference point vector information includes N elements, each element corresponds to coordinates of one position, a first value of the coordinates of the position indicates longitude, and a second value of the coordinates of the position indicates latitude. Herein, representation of the subsatellite point position is merely an example, may alternatively be extended to another position representation form, and is not limited to two-dimensional position coordinates.

The UE receives the first information from the first node.

Operation 502: The UE determines, based on a position of the UE and the first information, remaining service time corresponding to a zone in which the UE is located.

For example, the position of the UE is (lont, latt). The UE calculates, based on the position of the UE, a service elevation angle corresponding to the zone in which the UE is located, and the reference point vector information, the remaining service time corresponding to the zone in which the UE is located.

In an example, for a calculation rule, refer to the following formulas (1) to (3):

$${t}_{c} = \frac{1}{ω} arccos ( \frac{cos {γ}_{0}}{cos {γ}_{m}} ) \qquad ( 1 )$$

$${γ}_{m} = Min \{ 2 {sin}^{- 1} ( Ω ) \} \qquad ( 2 )$$

$$Ω = [ \sqrt{{sin}^{2} ( \frac{λ s - λ T}{2} )} + cos ( λ s ) \times cos ( λ T ) + cos ( λ s ) \times {sin}^{2} ( \frac{η s - η T}{2} ) ] \qquad ( 3 )$$

t_{c} is the remaining service time, and co is an angular velocity of a satellite in an earth-centered inertial (earth-centered inertial, ECI) coordinate system. γ₀, γₘ, λs, λT, ηs, ηT, and Ω respectively represent a service elevation angle configured on the network side, information related to a minimum elevation angle calculated by using the formula (2), satellite longitude, terminal longitude, satellite latitude, terminal latitude, and an intermediate variable calculated by using the formula (3).

Operation 503: The UE performs measurement on one or more adjacent neighboring cells before the remaining service time ends.

Operation 504: The UE determines a target cell based on the first information and longest service time.

For example, the UE performs neighboring cell measurement based on the first information, and determines a plurality of candidate neighboring cells on which handover/reselection can be performed. In addition, the UE calculates service duration of each of the plurality of candidate neighboring cells based on the service elevation angle corresponding to each of the one or more zones corresponding to the first node, and the reference point vector information corresponding to the first node. The UE may select the target cell from the plurality of candidate neighboring cells based on the longest service time, for example, select a candidate neighboring cell corresponding to the longest service time as the target cell.

In this example, the network side provides auxiliary information (for example, the service elevation angle corresponding to the one or more zones corresponding to the first node, and the reference point vector information corresponding to the first node) for the UE, so that the UE performs neighboring cell measurement before the remaining service time of the zone in which the UE is located ends, and selects the target cell based on a longest service time criterion to perform cell handover or reselection. This can reduce frequency of the cell handover/reselection. In this way, signaling overheads of mobility management are reduced.

For example, this application further provides a beam position-level mobility management (for example, cell handover/reselection) method, to reduce a quantity of to-be-measured neighboring cells on a UE side in cell handover/reselection triggered mainly by network mobility, and help reduce measurement overheads on the terminal side in a mobility management process.

FIG. 11 is a diagram of a neighboring cell relationship based on a longest service time criterion. In FIG. 11, different filling patterns represent different cells. For example, beam positions 1, 2, 9, 11, and 14 correspond to a cell A, and beam positions 7 and 15 correspond to a cell B. Based on the longest service time criterion, terminal devices in different zones are connected to different satellites. For example, the beam positions 1, 2, 9, 11, and 14 are a zone, and a terminal device in the zone is connected to a satellite 1; and the beam positions 7 and 15 are a zone, and a terminal device in the zone is connected to a satellite 2. Under this criterion, a beam position level change occurs on a neighboring cell relationship.

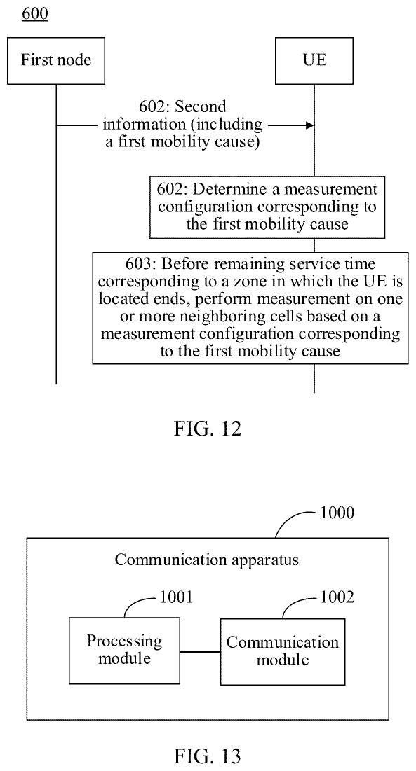

The following describes a specific implementation with reference to FIG. 12.

FIG. 12 shows an example of a mobility management method according to this application.

Operation 601: A first node sends second information to a terminal device in one or more zones corresponding to the first node, where the second information includes a first mobility cause and a measurement configuration corresponding to the first mobility cause.

The first mobility cause is one of triggering mainly based on terminal device mobility and triggering mainly based on network mobility. In other words, the first mobility cause may be specifically the triggering mainly based on the terminal device mobility or the triggering mainly based on the network mobility. The mobility cause of the triggering mainly based on the terminal device mobility corresponds to a first measurement configuration, and the mobility cause of the triggering mainly based on the network mobility corresponds to a second measurement configuration. The first measurement configuration and the second measurement configuration include different neighboring cell information (neighboring cell relationships).

For example, the second information may be represented as {mobility_cause, bowie_index, measurement configuration}. The mobility_cause may specifically include triggering mainly by UE mobility or triggering mainly by network mobility, which may be respectively represented as UE_mobility and network_mobility.

It is assumed that the mobility cause of the UE_mobility corresponds to a measurement configuration 1, and the mobility cause of the network_mobility corresponds to a measurement configuration 2. In this case, a configuration corresponding to the second information is specifically the following configuration 1 or configuration 2:

Configuration 1: {UE_mobility, {bw1, bw3, bwP}, measurement configuration 1}, where the UE_mobility is determined based on that a distance between a position of a UE and a beam position reference point is greater than a threshold 1.

Configuration 2: {network_mobility, {bw2, bw5, bwQ}, measurement configuration 2}, where the network_mobility is determined based on that the distance between the position of the UE and the beam position reference point is less than a threshold 2.

The measurement configuration 1/measurement configuration 2 may include one or more of the following information:
list information of a to-be-measured satellite/list information of a physical cell identifier (PCI), a to-be-measured frequency, polarization information, SMTC+offset information, a measurement time period, a position reference point vector, service elevation angle information, neighboring cell relationship information (to be specific, information about a serving satellite of an adjacent beam position corresponding to a beam position cluster), a set of neighboring satellites triggered mainly by network mobility, a valid time period, whether a neighboring cell is in an active state, and the like. One beam position cluster may include one or more beam positions. As described above, the configuration 1 and the configuration 2 are different due to different mobility causes. For example, the measurement configuration 1 and the measurement configuration 2 are different. Specifically, neighboring cell relationships in the measurement configuration 1 and the measurement configuration 2 are different.

Operation 602: The UE determines, based on the second information, the measurement configuration corresponding to the first mobility cause.

If the first mobility cause is the triggering mainly based on the UE mobility, the first mobility cause corresponds to the first measurement configuration; or if the first mobility cause is the triggering mainly based on the network mobility, the first mobility cause corresponds to the second measurement configuration.

Operation 603: Before remaining service time corresponding to a zone in which the UE is located ends, the UE performs measurement on one or more adjacent neighboring cells based on the measurement configuration corresponding to the first mobility cause.

In operation 603, the remaining service time corresponding to the zone in which the UE is located may be determined by the UE through calculation based on first information and the position of the UE. For details, refer to the example in FIG. 10. The details are not described again.

For example, if the first mobility cause is triggering mainly based on UE mobility, neighboring cell measurement is performed based on the first measurement configuration; or if the first mobility cause is triggering mainly based on network mobility, neighboring cell measurement is performed based on the second measurement configuration.

FIG. 11 is used as an example. It is assumed that the UE is located at the beam position 9. If the first mobility cause is the triggering mainly based on the UE mobility, a neighboring cell relationship included in the first measurement configuration may be: The beam position 9 is used as a serving cell, and neighboring cells of the serving cell may include a beam position 3, a beam position 10, the beam position 14, and a beam position 13; or if the first mobility cause is the triggering mainly based on the network mobility, a neighboring cell relationship included in the second measurement configuration may be: The beam position 9 is used as a serving cell, and neighboring cells of the serving cell may include the beam position 3, the beam position 10, and the beam position 13. It can be found by comparing the neighboring cell relationship in the first measurement configuration and the neighboring cell relationship in the second measurement configuration that, if the first mobility cause is triggering mainly based on network mobility, the neighboring cell of the serving cell does not include another neighboring cell corresponding to a same satellite, specifically, for example, the beam position 14 in FIG. 11. Therefore, when the UE performs neighboring cell measurement based on the second measurement configuration, a quantity of to-be-measured neighboring cells may be reduced, so that measurement overheads on a UE side are reduced.

The foregoing describes embodiments of this application in detail. The following describes a communication apparatus provided in this application.

Refer to FIG. 13. This application provides a communication apparatus 1000.

As shown in FIG. 13, the communication apparatus 1000 includes a processing module 1001 and a communication module 1002. The communication apparatus 1000 may be a terminal device, or may be a communication apparatus, for example, a chip, a chip system, or a circuit, that is used in the terminal device or that is used in combination with the terminal device and that can implement a method performed by the terminal device. Alternatively, the communication apparatus 1000 may be a network device, or may be a communication apparatus, for example, a chip, a chip system, or a circuit, that is used in the network device or that is used in combination with the network device and that can implement a method performed by the network device. For example, the network device may be the first node or the second node in method embodiments of this application.

The communication module may also be referred to as a transceiver module, a transceiver, a transceiver machine, a transceiver apparatus, or the like. The processing module may also be referred to as a processor, a processing board, a processing unit, a processing apparatus, or the like. In an embodiment, the communication module is configured to perform a sending operation and a receiving operation of the terminal device or the network device (for example, the first node or the second node) in the foregoing method. A component configured to implement a receiving function in the communication module may be considered as a receiving unit, and a component configured to implement a sending function in the communication module may be considered as a sending unit. That is, the communication module includes the receiving unit and the sending unit.

When the communication apparatus 1000 is used in the terminal device, the processing module 1001 may be configured to implement a processing function of the terminal device in embodiments in FIG. 4 to FIG. 12, and the communication module 1002 may be configured to implement receiving and sending functions of the terminal device in embodiments in FIG. 4 to FIG. 12.

When the communication apparatus 1000 is used in the network device, the processing module 1001 may be configured to implement a processing function of the network device (for example, the first node or the second node) in embodiments in FIG. 4 to FIG. 12, and the communication module 1002 may be configured to implement receiving and sending functions of the network device in embodiments in FIG. 4 to FIG. 12.

For example, if the communication apparatus 1000 is the first node, the processing module 1001 and the communication module 1002 have the following functions:

The communication module 1002 is configured to: send a first message to a second node, where the first message is used for configuring the second node to perform mobility management on a terminal device in one or more zones corresponding to the first node, the first message includes common part information and dedicated part information, the common part information includes common information of the terminal device in the one or more zones, and the dedicated part information includes specific information of each terminal device in the one or more zones; and
receive, from the second node, an acknowledgment message for the first message.

For example, the processing module 1001 is configured to perform one or more of the following processing: generating the first message, parsing the acknowledgment message for the first message, and the like.

In an embodiment, the communication module 1002 is further configured to:
send first information to the terminal device in the one or more zones, where the first information includes a service elevation angle corresponding to each of the one or more zones, the one or more zones include a first zone, an elevation angle of a terminal device in the first zone is greater than or equal to a service elevation angle corresponding to the first zone, and the first zone is any one of the one or more zones.

In an embodiment, the communication module 1002 is further configured to:
send second information to the terminal device in the one or more zones, where the second information includes a mobility cause and a measurement configuration corresponding to the mobility cause, the mobility cause includes triggering based on terminal device mobility or triggering based on network mobility, the mobility cause of the triggering based on the terminal device mobility corresponds to a first measurement configuration, the mobility cause of the triggering based on the network mobility corresponds to a second measurement configuration, and a to-be-measured neighboring cell included in the first measurement configuration and a to-be-measured neighboring cell included in the second measurement configuration are different.

For example, if the communication apparatus 1000 is the second node, the processing module 1001 and the communication module 1002 have the following functions:
The communication module 1002 is configured to: receive a first message from a first node, where the first message is used by the second node to perform mobility management on a terminal device in one or more zones corresponding to the first node, the first message includes common part information and dedicated part information, the common part information includes common information of the terminal device in the one or more zones, and the dedicated part information includes specific information of each terminal device in the one or more zones; and
send an acknowledgment message for the first message to the first node.

For example, the processing module 1001 is configured to perform one or more of the following processing: parsing the first message, generating the acknowledgment message for the first message, and the like.

For example, if the communication apparatus 1000 is the terminal device, the processing module 1001 and the communication module 1002 have the following functions:

The communication module 1002 is configured to obtain first information from a first node, where the first information includes a service elevation angle corresponding to each of one or more zones corresponding to the first node, the one or more zones include a first zone, an elevation angle of a terminal device in the first zone is greater than or equal to a service elevation angle corresponding to the first zone, and the first zone is any one of the one or more zones.

The processing module 1101 is configured to determine a target cell based on the first information, where the target cell is used for cell handover or cell reselection.

In an embodiment, the processing module 1001 is further configured to:
determine service duration of each of different neighboring cells based on the service elevation angle corresponding to each of the one or more zones and reference point vector information; and
determine the target cell from the neighboring cells based on the service duration of each of the different neighboring cells, where service duration of the target cell is not less than service duration of any other neighboring cell.

In an embodiment, the processing module 1001 is further configured to:
determine, based on a position of the processing module 1001 and the first information, remaining service time corresponding to a zone in which the processing module 1001 is located; and
perform neighboring cell measurement with the communication module 1102 within the remaining service time.

In an embodiment, if the communication apparatus 1000 is the terminal device, the processing module 1001 and the communication module 1002 may have the following functions:

The communication module 1002 is configured to obtain second information from a first node, where the second information includes a first mobility cause and a measurement configuration corresponding to the first mobility cause, the first mobility cause is one of triggering based on terminal device mobility and triggering based on network mobility, the triggering based on the terminal device mobility corresponds to a first measurement configuration, the triggering based on the network mobility corresponds to a second measurement configuration, and a to-be-measured neighboring cell included in the first measurement configuration and a to-be-measured neighboring cell included in the second measurement configuration are different.

The processing module 1001 is configured to perform neighboring cell measurement with the communication module 1002 based on the second information.

In an embodiment, the processing module 1001 is further configured to determine, based on the second information, the measurement configuration corresponding to the first mobility cause.

In addition, the processing module 1001 is specifically configured to perform neighboring cell measurement with the communication module 1002 based on the measurement configuration corresponding to the first mobility cause.

For other specific implementations of information, messages, and the like in apparatus embodiments, refer to method embodiments correspondingly. To avoid repetition, details are not described again.

In addition, it should be noted that the communication module and/or the processing module may be implemented by using a virtual module. For example, the processing module may be implemented by using a software functional unit or a virtual apparatus, and the communication module may be implemented by using a software function or a virtual apparatus. Alternatively, the processing module or the communication module may be implemented by using an entity apparatus. For example, if the apparatus is implemented by using a chip/chip circuit, the communication module may be an input/output circuit and/or a communication interface, and performs an input operation (corresponding to the foregoing receiving operation) and an output operation (corresponding to the foregoing sending operation). The processing module is an integrated processor, a microprocessor, an integrated circuit, a logic circuit, or the like.

In this apparatus embodiment of this application, the module division is an example, and is merely logical function division and may be another division manner during actual implementation. In addition, functional modules in the examples of this application may be integrated into one processor, or each of the functional modules may exist alone physically, or two or more modules may be integrated into one module. The integrated module may be implemented in a form of hardware, or may be implemented in a form of a software functional module.

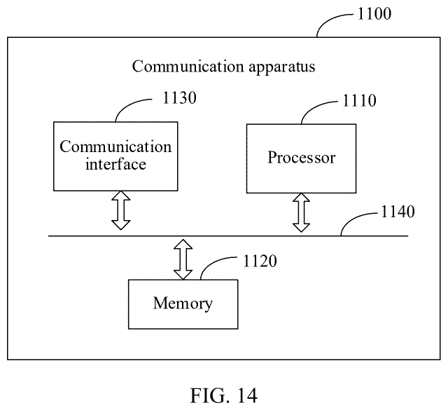

Refer to FIG. 14. This application further provides a communication apparatus 1100. In an embodiment, the communication apparatus 1100 may be a chip or a chip system. In an embodiment, in this application, the chip system may include a chip, or may include a chip and another discrete component.

The communication apparatus 1100 may be configured to implement a function of any network element (for example, the first node, the second node, or the terminal device) in the communication system described in the foregoing examples. The communication apparatus 1100 may include at least one processor 1110. In an embodiment, the processor 1110 is coupled to a memory. The memory may be located in the apparatus. Alternatively, the memory may be integrated with the processor. Alternatively, the memory may be located outside the apparatus. For example, the communication apparatus 1100 may further include at least one memory 1120. The memory 1120 stores a computer program, a computer program or instructions, and/or data necessary for implementing any one of the foregoing examples. The processor 1110 may execute the computer program stored in the memory 1120, to complete the method in any one of the foregoing examples.

The communication apparatus 1100 may further include a communication interface 1130, and the communication apparatus 1100 may exchange information with another device through the communication interface 1130. For example, the communication interface 1130 may be a transceiver, a circuit, a bus, a module, a pin, or a communication interface of another type. When the communication apparatus 1100 is a chip-type apparatus or circuit, the communication interface 1130 in the apparatus 1100 may alternatively be an input/output circuit, and may input information (or referred to as receiving information) and output information (or referred to as sending information). The processor is an integrated processor, a microprocessor, an integrated circuit, or a logic circuit. The processor may determine output information based on input information.

The coupling in this application may be an indirect coupling or a communication connection between apparatuses, units, or modules in an electrical form, a mechanical form, or another form, and is used for information exchange between the apparatuses, the units, or the modules. The processor 1110 may operate cooperatively with the memory 1120 and the communication interface 1130. A specific connection medium between the processor 1110, the memory 1120, and the communication interface 1130 is not limited in this application.

In an embodiment, as shown in FIG. 14, the processor 1110, the memory 1120, and the communication interface 1130 are connected to each other through a bus 1140. A type of the bus 1140 is not limited. For example, the bus 1140 may be a peripheral component interconnect (PCI) bus, an extended industry standard architecture (EISA) bus, or the like. The bus may be classified into an address bus, a data bus, a control bus, and the like. For ease of representation, only one bold line is used to represent the bus in FIG. 14, but this does not indicate that there is only one bus or only one type of bus.

In an embodiment, the memory and the processor in the foregoing apparatus embodiments may be physically independent units, or the memory and the processor may be integrated together. This is not limited in this specification.

In addition, this application further provides a computer-readable storage medium. The computer-readable storage medium stores computer instructions, and when the computer instructions are run on a computer, the operations and/or processing performed by the first node, the second node, or the terminal device in method embodiments of this application are/is performed.

In addition, this application further provides a computer program product. The computer program product includes computer program code or instructions, and when the computer program code or the instructions are run on a computer, the operations and/or processing performed by the first node, the second node, or the terminal device in method embodiments of this application are/is performed.

In this application, the processor may be a general-purpose processor, a digital signal processor, an application-specific integrated circuit, a field programmable gate array or another programmable logic device, a discrete gate or transistor logic device, or a discrete hardware component, and may implement or perform methods, steps, and logical block diagrams that are disclosed in this application. The general-purpose processor may be a microprocessor, any conventional processor, or the like. The steps of the methods disclosed with reference to this application may be directly implemented by a hardware processor, or may be implemented by a combination of hardware and a software module in a processor.

In this application, the memory may be a non-volatile memory, for example, a hard disk drive (HDD) or a solid-state drive (SSD), or may be a volatile memory, for example, a random access memory (RAM). The memory is any other medium that can carry or store expected program code in a form of an instruction or a data structure and that can be accessed by a computer, but is not limited thereto. The memory in this application may alternatively be a circuit or any other apparatus that can implement a storage function, and is configured to store program instructions and/or data.

In an embodiment, the communication apparatus 1100 may be used in a network device, for example, the first node or the second node in embodiments of this application. Specifically, the communication apparatus 1100 may be a network device, or may be an apparatus that can support the network device in implementing a corresponding function of the network device in any one of the foregoing examples. The memory 1120 stores a computer program (or instructions) and/or data for implementing the functions of the network device in any one of the foregoing examples. The processor 1110 may execute the computer program stored in the memory 1120, to complete the method performed by the network device (for example, the first node or the second node) in any one of the foregoing examples. The communication interface in the communication apparatus 1100 may be configured to interact with a terminal device, and send information to the terminal device or receive information from the terminal device.

In another possible implementation, the communication apparatus 1100 may be used in a terminal device. Specifically, the communication apparatus 1100 may be a terminal device, or may be an apparatus that can support the terminal device in implementing a function of the terminal device in any one of the foregoing examples. The memory 1120 stores a computer program (or instructions) and/or data for implementing the functions of the terminal device in any one of the foregoing examples. The processor 1110 may execute the computer program stored in the memory 1120, to complete the method performed by the terminal device in any one of the foregoing examples. The communication interface in the communication apparatus 1100 may be configured to interact with a network device (for example, the first node), and send information to the network device or receive information from the network device.

The communication apparatus 1100 provided in this example may be used in the network device (for example, the first node or the second node) to complete the method performed by a network side, or may be used in the terminal device to complete the method performed by the terminal device. Therefore, for technical effects that can be achieved by this embodiment, refer to the descriptions in the foregoing method embodiments. Details are not described herein again.

Based on the foregoing example, this application further provides a communication system. In an example, the communication system includes a first node and a second node. In an embodiment, the communication system further includes a terminal device. The communication system may implement the mobility management method provided in embodiments shown in FIG. 4 to FIG. 12.

All or some of the technical solutions provided in this application may be implemented by using software, hardware, firmware, or any combination thereof. When software is used to implement embodiments, all or a part of embodiments may be implemented in a form of a computer program product. The computer program product includes one or more computer instructions. When the computer program instructions are loaded and executed on a computer, the procedure or functions according to this application are all or partially generated. The computer may be a general-purpose computer, a dedicated computer, a computer network, a terminal device, an access network device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device like a server or a data center, integrating one or more usable media. The usable medium may be a magnetic medium (for example, a floppy disk, a hard disk, or a magnetic tape), an optical medium (for example, a digital video disc (DVD)), a semiconductor medium, or the like.

In this application, without a logical contradiction, mutual reference can be made between examples. For example, mutual reference can be made between methods and/or terms in method embodiments, mutual reference can be made between functions and/or terms in apparatus embodiments, and mutual reference can be made between functions and/or terms in apparatus examples and method examples.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

A plurality of (items) in embodiments of this application means two (items) or more than two (items). “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects. In addition, it should be understood that although terms such as first and second may be used in this disclosure to describe objects, these objects are not limited by these terms. These terms are merely used to distinguish the objects from each other.

The term “include” and any other variant thereof mentioned in embodiments of this application are intended to cover a non-exclusive inclusion. For example, a process, a method, a system, a product, or a device that includes a series of steps or units is not limited to the listed steps or units, but optionally further includes another unlisted step or unit, or optionally further includes another inherent step or unit of the process, the method, the product, or the device. In addition, words such as “example” or “for example” are used to represent giving examples, illustrations, or descriptions. Any method or design solution described in this application as “example” or “for example” should not be explained as being more preferred or advantageous over another method or design solution. To be precise, use of the words such as “example” or “for example” is intended to present a relative concept in a specific manner.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

When the functions are implemented in a form of a software functional unit and sold or used as an independent product, the functions may be stored in a computer-readable storage medium. Based on such an understanding, the technical solutions of this application essentially, or the part contributing to a conventional technology, or some of the technical solutions may be implemented in a form of a software product. The computer software product is stored in a storage medium, and includes several instructions for indicating a computing device (which may be a personal computer, a server, a network device, or the like) to perform all or a part of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A mobility management method, comprising:
sending, by a first node, a first message to a second node, wherein the first message is used for configuring the second node to perform mobility management on a terminal device in one or more zones corresponding to the first node, the first message comprises common part information and dedicated part information, the common part information comprises common information of the terminal device in the one or more zones, and the dedicated part information comprises specific information of each terminal device in the one or more zones; and
receiving, by the first node from the second node, an acknowledgment message for the first message.

2. The method according to claim 1, wherein the first node comprises a first satellite or a terrestrial station corresponding to the first satellite, and the second node comprises a second satellite or a terrestrial station corresponding to the second satellite;
the common part information comprises one or more of the following information:
an identifier of an interface application protocol between the first node and the second node, information about the one or more zones, a handover or reselection cause, a handover or reselection time period, identifiers of a source node and a destination node, an identifier of a target access and mobility management function (AMF), an identifier of a target user plane function (UPF), a handover or reselection priority, and a common measurement configuration; and
the terminal device in the one or more zones comprises a first terminal device, and specific information of the first terminal device comprises one or more of the following information:
an identifier related to the first terminal device, session information of the first terminal device, security-related information of the first terminal device, capability-related information of the first terminal device, a specific measurement configuration of the first terminal device, position information of the first terminal device, and speed vector information of the first terminal device.

3. The method according to claim 1, wherein the first node comprises a distributed unit (DU) of a first satellite, and the second node comprises a distributed unit (DU) of a second satellite;
the common part information comprises one or more of the following information:
configuration information of a source node or a source cell, radio resource configuration information, a target DU common configuration in access stratum context information, and information about the one or more zones; and
the terminal device in the one or more zones comprises a first terminal device, and specific information of the first terminal device comprises one or more of the following information:
capability information of the first terminal device and specific configuration information of the first terminal device.

4. The method according to claim 1, wherein the first node comprises a first satellite transmission reception point (TRP), and the second node comprises a second satellite TRP;
the common part information comprises one or more of the following information:
a common configuration of a source cell, ephemeris information corresponding to the first node, information about the one or more zones, a common measurement configuration, and timer information; and
the terminal device in the one or more zones comprises a first terminal device, and specific information of the first terminal device comprises one or more of the following information:
a specific identifier of the first terminal device and terminal-level access configuration information.

5. The method according to claim 2, wherein the information about the one or more zones comprises one or more of the following information:
a position reference point of each of the one or more zones, frequency information and/or polarization information corresponding to the one or more zones, a number of the one or more zones, partial bandwidth information corresponding to the one or more zones, a handover time period or a reselection time period corresponding to the one or more zones, and a timer corresponding to the one or more zones.

6. The method according to claim 1, wherein the method further comprises:
sending, by the first node, first information to the terminal device in the one or more zones, wherein the first information comprises a service elevation angle corresponding to each of the one or more zones, the one or more zones comprise a first zone, an elevation angle of a terminal device in the first zone is greater than or equal to a service elevation angle corresponding to the first zone, and the first zone is any one of the one or more zones.

7. The method according to claim 1, wherein the method further comprises:
sending, by the first node, second information to the terminal device in the one or more zones, wherein the second information comprises a mobility cause and a measurement configuration corresponding to the mobility cause, the mobility cause comprises triggering based on terminal device mobility or triggering based on network mobility, the mobility cause of the triggering based on the terminal device mobility corresponds to a first measurement configuration, the mobility cause of the triggering based on the network mobility corresponds to a second measurement configuration, and a to-be-measured neighboring cell comprised in the first measurement configuration and a to-be-measured neighboring cell comprised in the second measurement configuration are different.

8. The method according to claim 1, wherein the acknowledgment message for the first message comprises the common part information of the terminal device in the one or more zones and the dedicated part information of each terminal device in the one or more zones.

9. A communication apparatus, comprising:
a communication module, configured to: send a first message to a second node, wherein the first message is used for configuring the second node to perform mobility management on a terminal device in one or more zones corresponding to the communication apparatus, the first message comprises common part information and dedicated part information, the common part information comprises common information of the terminal device in the one or more zones, and the dedicated part information comprises specific information of each terminal device in the one or more zones; and
receive, from the second node, an acknowledgment message for the first message.

10. The communication apparatus according to claim 9, wherein the communication apparatus comprises a first satellite or a terrestrial station corresponding to the first satellite, and the second node comprises a second satellite or a terrestrial station corresponding to the second satellite;
the common part information comprises one or more of the following information:
an identifier of an interface application protocol between the communication apparatus and the second node, information about the one or more zones, a handover or reselection cause, a handover or reselection time period, identifiers of a source node and a destination node, an identifier of a target access and mobility management function (AMF), an identifier of a target user plane function (UPF), a handover or reselection priority, and a common measurement configuration; and
the terminal device in the one or more zones comprises a first terminal device, and specific information of the first terminal device comprises one or more of the following information:
an identifier related to the first terminal device, session information of the first terminal device, security-related information of the first terminal device, capability-related information of the first terminal device, a specific measurement configuration of the first terminal device, position information of the first terminal device, and speed vector information of the first terminal device.

11. The communication apparatus according to claim 9, wherein the communication apparatus comprises a distributed unit (DU) of a first satellite, and the second node comprises a distributed unit (DU) of a second satellite;
the common part information comprises one or more of the following information:
configuration information of a source node or a source cell, radio resource configuration information, a target DU common configuration in access stratum context information, and information about the one or more zones; and
the terminal device in the one or more zones comprises a first terminal device, and specific information of the first terminal device comprises one or more of the following information:
capability information of the first terminal device and specific configuration information of the first terminal device.

12. The communication apparatus according to claim 9, wherein the communication apparatus comprises a first satellite transmission reception point TRP, and the second node comprises a second satellite TRP;
the common part information comprises one or more of the following information:
a common configuration of a source cell, ephemeris information corresponding to the communication apparatus, information about the one or more zones, a common measurement configuration, and timer information; and
the terminal device in the one or more zones comprises a first terminal device, and specific information of the first terminal device comprises one or more of the following information:
a specific identifier of the first terminal device and terminal-level access configuration information.

13. The communication apparatus according to claim 10, wherein the information about the one or more zones comprises one or more of the following information:
a position reference point of each of the one or more zones, frequency information and/or polarization information corresponding to the one or more zones, a number of the one or more zones, partial bandwidth information corresponding to the one or more zones, a handover time period or a reselection time period corresponding to the one or more zones, and a timer corresponding to the one or more zones.

14. The communication apparatus according to claim 9, wherein the communication module is further configured to:
send first information to the terminal device in the one or more zones, wherein the first information comprises a service elevation angle corresponding to each of the one or more zones, the one or more zones comprise a first zone, an elevation angle of a terminal device in the first zone is greater than or equal to a service elevation angle corresponding to the first zone, and the first zone is any one of the one or more zones.

15. The communication apparatus according to claim 9, wherein the communication module is further configured to:
send second information to the terminal device in the one or more zones, wherein the second information comprises a mobility cause and a measurement configuration corresponding to the mobility cause, the mobility cause comprises triggering based on terminal device mobility or triggering based on network mobility, the mobility cause of the triggering based on the terminal device mobility corresponds to a first measurement configuration, the mobility cause of the triggering based on the network mobility corresponds to a second measurement configuration, and a to-be-measured neighboring cell comprised in the first measurement configuration and a to-be-measured neighboring cell comprised in the second measurement configuration are different.

16. The communication apparatus according to claim 9, wherein the acknowledgment message for the first message comprises the common part information of the terminal device in the one or more zones and the dedicated part information of each terminal device in the one or more zones.

17. A communication apparatus, comprising:
a communication module, configured to obtain second information from a first node, wherein the second information comprises a first mobility cause and a measurement configuration corresponding to the first mobility cause, the first mobility cause is one of triggering based on terminal device mobility and triggering based on network mobility, the triggering based on the terminal device mobility corresponds to a first measurement configuration, the triggering based on the network mobility corresponds to a second measurement configuration, and a to-be-measured neighboring cell comprised in the first measurement configuration and a to-be-measured neighboring cell comprised in the second measurement configuration are different; and
a processing module, configured to perform neighboring cell measurement based on the second information.

18. The communication apparatus according to claim 17, wherein the processing module is configured to:
determine, based on the second information, the measurement configuration corresponding to the first mobility cause; and
perform the neighboring cell measurement with the communication module based on the measurement configuration corresponding to the first mobility cause.
